(19) United States
(12) Patent Application Publication
(10) Pub. No.: US 2011/0071893 A1
(43) Pub. Date: Mar. 24, 2011

(54) SYSTEM AND METHOD FOR INTERACTIVELY CONNECTING USERS AND THIRD PARTY PROVIDERS TO INDIVIDUAL OR AGGREGATED TO-DO LIST TASK ITEMS OF USERS WITHIN THE TASK MANAGEMENT SYSTEM

(76) Inventors: Harshita Malhotra, Irving, TX (US); Rajita Singh, Irving, TX (US); Satnam Singh, Irving, TX (US); Gurmeet Singh, Irving, TX (US)

(21) Appl. No.: 12/889,177

(22) Filed: Sep. 23, 2010

Related U.S. Application Data
(60) Provisional application No. 61/244,926, filed on Sep. 23, 2009.

(51) Int. Cl. G06Q 30/00; G06F 15/173; G06F 15/16

(52) U.S. Cl. 705/14.23; 709/225; 709/206

(57) ABSTRACT

A system and method for delivering advertising, solicitation for offers, or offers of assistance to a user based on a user created to-do list task items wherein the user has requested such advertising, solicitation or assistance to be telephonically, wirelessly or electronically delivered and associated with said to-do list task items thereby aiding the user in the performance of his or her to-do list task items. The user to-do list task items may consist of calendared events, appointments, tasks, solicitations for offers, or other requests for assistance or information as the user may desire from other users of the task management system or third party providers. The present invention allows third party providers to connect to user authorized portions of said user's to-do list task items for the purposes of linking advertising, solicitation or assistance through, in part, a unique identifier (a contact information depository of record “CIDOR”).

### CROSS-REFERENCE TO RELATED APPLICATIONS

This application claims the benefit of U.S. Provisional Patent Application No. 61/244,926 filed Sep. 23, 2009, and entitled “SYSTEM AND METHOD FOR INTERACTIVELY CONNECTING PROVIDERS TO USER'S INDIVIDUAL OR AGGREGATED TO DO-LISTS”, the entire disclosure of which is incorporated herein by reference.

This application further claims the benefit of U.S. Provisional Patent Application No. 61/260,257 filed Nov. 11, 2009, and entitled “SYSTEM AND METHOD FOR USER ENGAGEMENT IN TO-DO LIST TASK MANAGEMENT”, the entire disclosure of which is incorporated herein by reference.

### TECHNICAL FIELD

The present invention relates generally to an electronic task management system and method, and more particularly, to an electronic system and method for providing solicitation for offers, from third party providers and/or task management system users, for review and acceptance by a task management system user for said user's inclusion into a to-do list task item within a task management system calendar, such system and method, optionally including, the issuance of rewards associated with the completion of said solicitation for offers.

### REFERENCE TO BE CITED

U.S. Patent Documents

| | | |
|---|---|---|
| Feinleib; Aug. 7, 2001 | Electronic Reminder System | U.S. Pat. No. 6,272,532 |
| | With Universal Email Input | |
| Suzuki; Jan. 20, 2004 | Interactive To-Do List Item | U.S. Pat. No. 6,680,675 |
| | Notification System Including | |
| | GPS Interface | |
| Loucks; Jul. 6, 2004 | Remote Reminder of | U.S. Pat. No. 6,760,4512 |
| | Scheduled Events | |
| Singh; May 5, 2009 | Apparatus and Method for | U.S. Pat. No. 7,528,713 |
| | Providing a Task Reminder | |
| | Based on Travel History | |
| Eaton; Mar. 21, 2006 | Method and Apparatus for | U.S. Pat. No. 7,016,855 |
| | Managing a Task List Using | |
| | Location Based Filtering | |
| Upon, Jun. 2, 2009 | Proximity-Based Task Alerts | U.S. Pat. No. 7,541,940 |
| Hickman; Jun. 25, 2009 | System and Method for | U.S. Pat. No. 7,082,439 |
| | Electronic Message | |
| | Notification | |
| Hires; Feb. 5, 2008 | Method and System for | U.S. Pat. No. 7,327,834 |
| | Providing Interactive Event | |
| | Reminders | |
| Miller; May 4, 1999 | Method and System for | U.S. Pat. No. 5,899,979 |
| | Automatically Integrating | |
| | Scheduled Work Items Onto | |
| | An Electronic Calendar | |
| Mathewson, Dec. 4, 2007 | Time-Sensitive Messages and | U.S. Pat. No. 7,305,441 |
| | Events | |
| Kepecs, Aug. 30, 2005 | Method and System for | U.S. Pat. No. 6,937,995 |
| | Distributing and Reconciling | |
| | Electronic Promotions | |
| Gilley; Mar. 27, 2008 | Rewards System | U.S. Pat. No. 11/729,170 |
| Hayes; Oct. 16, 2003 | Customer Messaging Services | 2003/0195811 A1 |
| Fano; Apr. 28, 2005 | Location-based filtering for | 2005/0091118 A1 |
| | Shopping Agent in the Physical | |
| | World | |

Applicant references the above patents for inclusion in the examiner's analysis of the system and method presented herein.

For reference, the present invention is distinguishable from U.S. Pat. No. 6,272,532, Feinleib, Aug. 7, 2001 (the '532 Patent), in that an e-mail message is not the primary vehicle through which a reminder message is sent to users and no extraction of e-mails for reminder message is performed. Further, while that invention seeks to facilitate reminders of work to be done, it does so using an ability to issue commands to the system via email message. The present invention does not use commands issued through e-mail.

The present invention is also distinguishable from U.S. Pat. No. 6, 680,675, Suzuki (the “'675 Patent”) in that the '675 Patent is a system and method of “alerting a user of an item on a to-do list if the user is detected to be close to the item's performance location”. The present invention does not require a performance location as a prerequisite to any alerting or reminders, nor does the present invention require that a to-do list task item be entered into a mobile user terminal having a memory, with each item on the to-do list task item being associated with a performance location. In fact the present invention teaches away from such efforts in that access to to-do list task items are coordinated in a server to which web enabled devices can freely connected. A mobile user terminal does not permanently store any to-do list task items nor is such device required to access a user's to-do list task item or calendar. The '675 Patent is further inapposite to the present invention in that the present invention does require downloading of the to-do list to the mobile user terminal from the host computer or server.

The present invention is further distinguishable from U.S. Pat. No. 5,899,979, Miller, et. al (the “'979 Patent”) in that the '979 Patent teaches the assignment of a user defined priority to a to-do list task item, and such to-do list task item is to be merged with the event list of the calendaring program of completion of said to-do list task item. The present invention does not require assigning any an alphabetic priority indicator to a to-do list task item. Lastly, the use of the phrase a “to-do list task item” is common vernacular and it not in and of itself a novel idea.

The present invention is further distinguishable from US Patent Application No. 2003/0195811, Hayes, Marc F. Jr; et al (the “'811 Application”) in that the '811 Application teaches the step of permitting a customer to submit a natural language query which is requested by a messaging and alert service. The '811 Application is not concerned with the maintenance of a to-do list task item within a stored calendar, accessible and modifiable by users of a task management system, but rather blasting alerts to certain user defined devices within a user profile, such concept not unique in and of itself. Lastly, and importantly, the '811 Application is incapable of facilitating the solicitation of offer concept embodied in the present invention wherein possible business transactions are consummated based on user interactions and third party providers' performance of non-routine services and/or product requesters generated by a user within the task management system. While the '811 Application and the present invention do share, generally, the non novel concept of using a computer-readable medium that stores computer executable instructions for a messaging and alerting system (or task management system), the instructions causing a computer to: enroll a customer in the messaging and alert service; store a list of businesses selected by the customer; store a customer contact hierarchy list; and contact the customer according to the customer contact hierarchy, there is no requirement that a user be limited to any selected businesses and, in fact, the present invention teaches away from such limitation as a user can interact with any system user for any non-business task regardless of whether an alert is created by such other users of the task management system. Mere similarities between the '811 Application and the present invention with regards to the types of information stored, given such information is usual, customary and not novel, even in a manual implementation of said inventions, does not cause the present invention to read upon the '811 Application as the two implementation methods are wholly unique and inapposite.

The present invention is further distinguishable from U.S. Pat. No. 7,528,713, Singh; (the “'713 Patent”) in that the '713 Patent contains a “monitoring module configured to monitor a location of a user via a mobile communication device associated with the user at predetermined time intervals for tracking historical travel information of the user”. An integral part of the '713 Patent is that it must further query a position locator system to identify the location of the mobile communication device at least one of at a fixed sampling interval and at a sampling interval proportional to at least one of a velocity and an expected velocity of the mobile communication device. While the present invention, if available, does, optionally, use a mobile device GPS locator to locate the user to coordinate potential third party solicitation for offers within such users general vicinity, the present invention does not monitor a users location, track time intervals, or record historical travel information. Further, the '713 Patent is inapposite to the present invention in that the present invention has no need to create interval sampling and determine any velocity, or expected velocity, of a users; mobile device. Any overlap between the '713 Patent and the present invention is in the sole fact that each utilize a calendaring function which can be configured to provide a reminder of an appointment or task to the user at or near the time the appointment has been scheduled, such functions and reminder not in and of themselves novel and consistent with standard functions found in most calendaring devices.

The present invention is further distinguishable from U.S. Pat. No. 7,016,855, Eaton, et al (the “'855 Patent”) in that the '855 Patent teaches the aspect of generating a reminder for the outstanding task when the communication device is within the boundary defined area by use of proximity parameters such a maximum travel distance, frequency adjustments based on rate of travel associated with a communication device, and boundary adjustments based on number of outstanding tasks. The '855 Patent is geared towards location-determining capabilities of mobile devices, and not interactive task management among users and third party providers within a task management system. Further, the '855 Patent, unlike the present invention, is not concerned with aggregation of users calendar data for leveraging third party solicitations for offers to such aggregated users, such aggregation not limited by travel distance, frequency adjustments or location of any one mobile device. While the '855 Patent and the present invention do allow, albeit in a difference way, for customized offers from local stores to be delivered to a user, such overlap does not in and of itself render the present invention unpatentable over the '855 Patent.

Likewise, the present invention is distinguishable from U.S. Pat. No. 7,541,940, Upton (the “'940 Patent”) in that the '940 Patent requires “determining whether the mobile computing device is within the selected proximity of the location for the each task.” The present invention has no such required determination or selected proximity. Further, while the '940 Patent teaches task alarm types of a graphic alarm, a sound alarm, a flashing visual alarm, and a vibration alarm, such types are in and of themselves not novel and, importantly, the presentation invention allows for multi-media content in a plethora of formats not limited to those taught by the '940 Patent.

The present invention is further distinguishable from U.S. Pat. No. 6,937,995, Kepecs (the '“995 Patent”) in that the '995 Patent requires that each consumer account have a limited direct identification of said consumer, excludes the identification of said consumer by name, and requires at least one financial institution account number and a purchasing history for each consumer. While the present invention does provide for the distributing and redeeming electronic promotions, it does so without the limitations specified in the '995 Patent. In fact, the present invention requires no financial institution account numbers, does not require a purchasing history for any user with any third party offer provider, and further maintains no account specific information.

The present invention is further distinguishable from US Patent Application No. 2008/0077489, Gilley (the “'489 Application”) in that the '489 Application requires user accounts to be linked with predetermined activity, distribution upon competition, and a commercial store. The present invention has no requirement for predetermined activity and, further, there is no linking of accounts from one user to another, as required by the '489 Application.

The present invention is further distinguishable from US Patent Application No. 2005/0091118, Fano (the “'118 Application”) in that the '118 Application requires a retail-based agent to respond to a specific user query with pre-defined parameters, and further fails to instruct as to aggregating multiple user to-do list tasks (some of which may be solicitations for offers) into a single to-do list task which can be matched against an offer database. Lastly, there is no concept of group to-do list tasks, calendaring, rewards, or content management associated with to-do list tasks. The '118 Application lacks the ability for collaboration and encouragement between users, and is nothing more than a one to one buy-sell relationship between a user and a supplier.

### BACKGROUND OF THE INVENTION

A lot of tools exist in the market today for the user to enter, organize and manage their to-do lists tasks within their calendars. Even with all the available tools such as Microsoft Outlook, Post-It notes, diaries, automated lists, etc., it is still very problematic to take action and get things done timely and effective manner. Managing the to-do list becomes the biggest task in itself given the performance of a user to-do list task item through completion often involves multiple parties, including the following: i) the individual, group, or business initiating the to-do list task item; ii) the individual, group, or business required to perform and complete the to-do list task item; and iii) the individual, group, or business willing and able to provide help, services or products for completing the to-do list task item. Without sufficient support and incentives, the user loses interest in his or her to-do list task item and, ultimately, is unable to complete the to-do list task item.

Notwithstanding the foregoing, there are at least five (5) limitations to the current services that exist today in the market place: i) users do not remember their to-do list task items because they lack a reminder at the right time and at the right place at the right device; ii) users are unable to accomplish such to-do list task items because no one is pushing them, reminding them, or asking/tasking them in a socially connected way, and the rewards for accomplishing such to-do list task items are either deminimis or are not often associated or poorly associated with the completion of a to-do list task items; iii) managing a to-do list is boring, and not interactive or collaborative; iv) there is an overload of information and communication hitting the user via multiple channels and creating confusion regarding what to-do list task items are to be performed; and v) third parties are unable to assist the user because there is no ability to share and/or match user to-do list task items with companies or individuals that can assist in completing the to-do list task items.

The present invention seeks to address the above issues by facilitating the interaction of the user's to-do list task items with those who stand to benefit from the performance of the to-do list task items. For example and not by way of limitation, the present invention provides offers and reminders that are contextual to the list of current to-do list task items and, optionally, provides location specific offers and reminders/alerts. These reminders/alerts can be made interesting so that the user is engaged and hence higher chance of accomplishing the tasks. Others users can add to-do list task items on a user's to-do list calendar and remind the user to accomplish the task in a “socially connected” way. Further, individual, group, or business can attach incentives or “rewards” to encourage completion of a to-do lisftask item. These individual, group or business can make completing a to-do list task item interactive, and encourage the timely completion of such to-do list task item. Reward criteria may consist of digital media, points, coupons, and message information, such reward criteria stored within a Reward Database for use by user within the task management system, such reward criteria initially stored in an Offer Database. Upon consummation of a transaction between a user and a third party provider (or, optionally, a user and another user), the task management system transfers the reward criteria of the solicitation for offer from an Offer Database and stores such reward criteria in a Reward Database, such stored reward criteria referentially associated with said User Account Database of said user. A user is then able to redeem such reward criteria at a later date, or contemporaneously with the transaction consummated.

The present invention also allows for the aggregation of individual to-do list task items of various users into an aggregated to-do list task item submitted to third party providers for consideration which may result in price reductions for such aggregated purchases. Rewards for completing an aggregated to-do list task item can be allocated by the task management system among the aggregated users. By way of example only and not as a limitation, the task management system can aggregate all to-do list task items of users who desire to purchase a 50″ television in order to achieve the best deal then available from a third party provider. Further, users can designate groups within the task management system to associate and perform shared to-do list task items. Creating group to-do list task items helps users collaborate towards their mutual goal.

The present invention seeks to further address the above prior art limitations by facilitating contextually based to-do list task item management wherein other users are available to provide assistance, or conversely, third party providers can review, if allowed by the user, such users to-do list task items and determine whether such third party providers desire to send the user a solicitation for offer. Information that is contextual to the to-do list task is provided to help in completing the task. By way of example only and not as a limitation, a user's to-do list task item to get the plumbing fixed may be accessible to third party offer providers and referentially associated with such third party solicitation for offers, and other information discretionarily provided by third party providers to a user, and, potentially, such solicitation for offers optionally linkable within such user to-do list task item and accessible by such user by user selection.

The task management system also makes it fun and rewarding for the users to strive to complete their to-do list task items by providing the capability to add personas to their to-do list task items, group to-do list task items or alerts. By way of example only and not as a limitation, these personas include images, sounds, icons, sketches, photos of a celebrity/personality, voice of the celebrity/personality, etc. (i.e. user may want the voice of Arnold Schwarzenegger to remind him/her of the to-do list task items.)

The present invention seeks further to address the issue of information and communication overload. It is a well know fact that information overload can and does bombard a user with the same information through multiple communication means. For example only and not by way of limitation, people are flooded today with communication to their phones, emails, texting, direct mail, etc. Users of those devices often receive the same information in multiple formats and in multiple ways with no real ability to filter out such information. The present invention allows the user to provide a user created acronym which, when used in conjunction with user preferences of the task management system, may forward information to one communication means to the exclusion of others. For example only and not by way of limitation, a user may wish to receive notices concerning movies to a user's cellular device through SMS, but not to the user's e-mail on that same device. The present invention would proactively filter the information for targeted delivery to the user, as specified by the user. One user created acronym (or “CIDOR” or Customer Information Depository of Record, a feature of the present system), will act as the gateway for all user messages to be measured and filter against a user preferences. No longer will a user be exposed to the aforementioned bombardment. Further, without the present invention, some users often miss relevant information because third party providers have outdated information in which to contact the user (e.g., old email, expired phone number, previous address, etc.). By using CIDOR, the present invention provides third party providers or other users a universal way to maintain contact with a user regardless of how and when such users contact information of message devices change. CIDOR becomes the universal identifier for the user, as determined by the user as a part of his personal preferences. By using CIDOR, users can provide others a quick and easy way to interact with a users to-do list task items and/or a user calendar to facilitate the completion of a users to-do list task items; right place, right time and the right device

### SUMMARY

A system and method for telephonically, wirelessly or electronically delivering advertising or other solicitations or offers of assistance or information or reminder or alert to a user based on a user related to-do list task item wherein the user has authorized said advertising, solicitation or assistance to be delivered as associated with said to-do list task item thereby aiding the user in the performance of his or her to-do list task item tasks, said system and method optionally delivered through rewards and incentives encouraging users to perform tasks in a socially connected way. A user to-do list task item may consist of calendared events, appointments, tasks, solicitation for offers, or other requests for assistance or information (collectively, “solicitation for offer(s)”). A user to-do list task item may be modified by the user, an authorized third party provider (such as an advertiser, solicitor or assistor), or any institution, or any business, or service provider, or such other task management system users as the user may authorize from time to time. The third party providers may be individuals or businesses or institutions providing information, services, products, assistance or other solicitation for offers may be customers, advertisers, solicitors, assistors, or any institution, or any business, or any service provider or other task management system users.

The task management system maintains a centralized User Calendar Database (the “User Calendar Database”—FIG. 1) the contents of which are customizable and definable by the task management system, a user, or an authorized third party provider by entry of to-do list task items and/or linkable solicitation for offers associated with such to-do list task items. The User Calendar Database can be automatically or manually populated, viewed, modified, listened to, or updated with information by users or third party providers using an input terminal (see generally, FIG. 1, FIG. 6, FIG. 9, FIG. 11, FIG. 13, FIG. 15 and FIG. 16) through a plurality of means such as a web based task management system or other internet or intranet user interface, offline or online widget application, logging on remotely to a task management system user account associated with the User Calendar Database, emails to said task management system account, and other means, such as a touch tone phone, mobile phone, mobile terminal (FIG. 1A), SMS, image, video, MMS, voice, voice mail, electronic mail, instant messaging, widget application, software application, or automated voice announcement software or voice recognition software, Application Programming Interface (API), or Kiosks or Point of Sale System (POS).

The user can additionally interact with the User Calendar Database in multiple ways. Some examples, include but are not limited to, are the user's ability to mark to-do list task items as public or shared with group(s), ability to join an existing public to-do list task item and/or seek information from other users with similar public to-do list task items or utilize the size of the “joint to-do list task item” to receive better offers from third party providers.

The User Calendar Database may connect and receive information and content from a centralized Offer Database (FIG. 1) (the “Offer Database”) that contains then current advertisements, solicitations, information, content and/or offers that are populated by third party providers or the task management system. For example only and not by way of limitation, third party providers may periodically refresh advertisements, solicitations, information, content and/or offers based on, but not limited to, individually defined user profiles and/or user to-do list, or an aggregation of all, or partial sampling of, user to-do list task items found in the User Calendar Database.

The individual user profile associated with the User Calendar Database, as established by a task management system administrator, may be viewed, accessed, or modified according to user defined preferences and account settings stored within the User Account Database (see generally, FIG. 2), including, but not limited to, capturing user preferences for one or more means of authorizing a third party provider to communicate with said user, such means may include regular mail, express mail, phone, mobile phone, mobile terminal, voice mail, electronic mail, SMS, MMS, Kiosks, POS, instant messaging, or other form of Internet or wireless communication (collectively, the “User Profile”). A User Profile, may further include group preferences of task management system users who are familial to said user, list of task management system users who are within said user's social network, list of task management system users who are non-profit business entities, list of task management system users who are service providers, list of task management system users who are customers of said user. The User Profile, and optionally each to-do list task item stored in the User Calendar Database, may further contain solicitation for offer preferences such as preferred offer location, brand name, purchase price, rebate, volume discount, environmentally green product, delivery, and consent to aggregation of said user's offer preferences data with other users within the task management system. Likewise, the task management system will store in the Offer Database third party provider and other users solicitations for offers with corresponding requests for assistance, purchase location, brand and product information, price, rebate, volume discount, environmentally green indicators, delivery requirements, and reward criteria, as applicable. The task management system, as more fully explained throughout, may then allow third party providers or other task management system users, as applicable, to access and/or query using the preferences contained within the User Profile, to-do-list task items of the User Calendar Database, and/or the Offer Database. Further, the task management system may automatically and periodically access and/or query using the preferences contained within the User Profile, to-do-list task items of the User Calendar Database and/or the Offer Database and, if user allowed, create new or associate existing to-do list task items with linkable references to a solicitation for offer within the Offer Database, or notify relevant third party providers of a user's desire for a solicitation for offer if no similar offer exists in the Offer Database.

For the purpose of this invention, the usage and definition of “mobile” extends to include users with devices that have mobile connectivity to the internet and/or intranet. Examples of such devices may include but are not limited to mobile phones, GPS enabled devices, music players, video players, electronic book readers, and other internet or network enabled devices.

The User Profile further contains not only a user's personal information and preferences, but also subscription/un-subscription requests related to receiving to-do action item reminders, advertisements, solicitations, information, content and/or offers from authorized third party providers, including what to-do list task items can be accessed by third party providers. The User Profile and associated User Calendar Database are periodically compared with the Offer Database, and, thereafter, the solicitation for offers within the Offer Database is delivered to the user through delivery means set forth in the User Profile wherein the task management system inserts linkable objects into a user's to-do list task item which then links to the relevant solicitation for offers contained within the Offer Database (FIG. 7). Such periodic comparison analyzes, automatically or as requested by a task management system administrator, the User Profile, User Calendar Database, and Offer Database for record pointers or links between such databases, and if none are found, then by to-do list task items, descriptions, words, abbreviations, short hand texts, dates, times, locations, and all other available like information and content within the task management system, both aggregated and individually with the User Calendar Database and Offer Database, and attempts to identify, match and deliver such information and content to a user or third party provider, as applicable. The present invention may allow a task management system administrator to configure filters to implement an overall rule set as established by the person or entity implementing the present invention.

The information and content within the Offer Database consist of a third party provider identifier, location, category, description of the third party provider, description of the solicitation for offer, public solicitations for offers, private solicitations for offers intended for specific users, offer criteria, reward criteria, linkable personas, and such content may further include an e-mail, file attachment, text, text streams, text messages, instant messages, voice messages, multi-media messages, video, video streams, audio, audio streams, HTML, JAVA, XML, Flash, data, periodic reminders, banners, graphics, images, image streams, or Internet web links, all such information and content delivered in accordance with the User Profile preferences or subscriptions. Third party providers may consist of other users of the task management system. Such information is periodically refreshed and redelivered, if applicable, as the User Profile, User terminal location, User Calendar Database, and Offer Database are periodically compared with the user's or third party provider's, as applicable, then current changes to the User Profile, the User Calendar Database, the Offer Database, or all three.

The Offer Database may be automatically (or manually) periodically viewed, updated or modified by third party providers or the task management system (FIG. 9, FIG. 11, FIG. 13 and FIG. 16). Users or authorized third party providers can view, listen, create, update or modify to-do list task items within the User Calendar Database using an input terminal through a plurality of means such as a widget application, logging on to the task management system, emails to said task management system, and other means, such as a touch tone phone, mobile phone, mobile terminal, SMS, voice, voice mail, electronic mail, instant messaging, widget application, software application, Automatic Programming Interface (API), or automated voice announcement software or voice recognition software. Periodic data feeds from the task management system consisting of user to-do list task items within the User Calendar Database can notify third party providers of changes to a user's to-do list task items and, thereafter, third party providers can employ either an automatic or manual solution to populate the Offer Database with linkable solicitation for offers for association with a user's to-do list task item within the User Calendar Database, as allowed by each User Profile. The task management system sets record pointers or links within the User Calendar Database to the Offer Database information which the third party provider intended to associate with the User Calendar Database for the purposes of providing relevant solicitation for offers. Authorized third party providers can access and view a user's to-do list task item(s) contained with the User Calendar Database through a computer terminal, mobile terminal, voice terminal, display device and input device, or by automated software scripts written to access the task management system for the purpose of populating the Offer Database with linkable solicitation for offers. The Offer Database and User Calendar Database may periodically refresh based on individually defined user profiles, a user to-do list take items, an aggregation of all user-to-do list task items, or a partial sampling of all user to-do list task items found in the User Calendar Database, as allowed by individual user authorization in the User Profile and task management system administrator defined parameters.

The task management system may connect and receive information and content from a centralized Offer Database (the “Offer Database”) that contains then current solicitations for offer for incorporation into a users to-do list task item in the User Calendar Database, if the user so desires, including action details, due dates, and the number of reward points and/or other criteria related to the Offer (FIG. 13). Such action provides the user of the task management system the option to avail solicitation for offers that are not linked to any current user to-do list task item in the User Calendar Database but, if the user so desires, the user may select the solicitation for offer and create a new user to-do list task item consisting of a link to the user selected solicitation for offer within the Offer Database.

Information and content contained within the Offer Database is delivered to user in multiple ways. Said information and content is electronically inserted, either in its entirety or by a linking means, within the user to-do list task item found in the User Calendar Database thereby allowing the relevant information and content to coexist, or linkable, within a user to-do list task item and accessible by the user as determined in the User Profile (see generally FIG. 2). The information and content may also be included in a user defined time interval, such as minutes, hours, days,-weeks, month or such other calendared period, to-do task list item reminders which may populate as a calendared item on the user to-do list task item within the User Calendar Database or delivered to the user based on user profile. In addition to the information and content provided by third party providers, as delivered by the task management system, a user of the present invention may also proactively and selectively request offers, advertisements, solicitations, assistance, information and content from third party providers through the creation of a to-do list task item within the User Calendar Database; thereafter, such requests further refined and performed in accordance with the User Profile and the task management system.

Users can view and/or the task management system can display items in the Offer Database based on specific filters (e.g. location, preferences etc.) applied manually or automatically. Users can then select items of interest from the Offer Database. Such user action(s) results in population of the item and/or related information and/or linkable object in the User Calendar Database and other concurrently used or other user's calendar in said User Calendar Databases that the user is authorized to modify (FIG. 13)

Users of the task management system can opt to aggregate user to-do task list items with similar to-do list task items of other users of the task management system. When aggregated, similar to-do list task items will appear as an aggregated to-do list task item to third party providers. By leveraging their purchasing power, task management system users can get better pricing and terms on the solicitation for offers from the third party providers. (see generally FIG. 10 and FIG. 11). For example and not by way of limitation, the task management system can aggregate to-do list task items based on categorization of like purchases, or simple purchase volume of unlike purchases of products and/or services.

For devices capable of determining user location) or IP enabled devices (e.g. mobile phone, mobile terminal, PDA, automobile navigation, desktop, kiosk, etc.), users with such devices, as requested within the User Profile, will be provided solicitations for offers based on User Account Database (User Profile and user preferences within the User Profile), User Calendar Database, Offer Database, and user terminal location and/or address, if available, as indicated by user location or IP address, as applicable. In case of users without device capable of determining user location or IP address, the user may present to the task management system a user location through zip code, or address, or phone number, or visual picture or video. If the user is in transit with a device capable of determining user location, the task management system can, if allowed by the user in the User Profile, periodically receive updated user location information from the user device for the purposes of delivering location specific solicitation for offers contained within the Offer Database, which may include the task management system refreshing (or updating) a user to-do list task item with updated linkable objects to the Offer Database based on user's then current location, and a notification may be sent to user when such to-do list task item update occurs. Note that a user need not enter a pre-defined location related to the to-do list of the User Calendar Database. In addition, the task management system may provide a plethora of ways of providing solicitation for offers from the Offer Database which may be delivered and/or accessed to/by a user with or without range restrictions. By way of example and not as a limitation, if the user to-do list task item has ‘remember to buy orange juice’, this does not have any pre-defined location and the user will be provided with linkable solicitations for offers from third party providers to complete the to-do list task item in the User Calendar Database, such linkable solicitations for offers updated within such to-do list task item based on user location. An example representation of offers can include all offers that can be then sorted by various parameters found in the User Profile (e.g., offer preferences, device preferences, distance, rating, price, brand, etc.). These parameters can be task management system defined and/or user defined. Alternatively, or additionally, the user may create pre-defined locations as a part of the User Profile or the to-do list task item tasks of the User Calendar Database.

The task management system will employ universal identifier/tag that is unique to the user and/or to his or her to-do list task items contained within the User Calendar Database. The universal identifier serves as the “Contact Information Depository Of Record” or “CIDOR ID”. The CIDOR ID is established through a unique acronym selected by the user and stored in the task management system. The user can provide this unique identifier to anyone he/she wishes to remind them about, but not limited to, events, tasks, appointments, promotions, action items, to-do items, etc. The unique identifier need not be numeric or alphabetic, but can be a combination or numbers, words or symbols or image. Upon registration in the task management system, a user is provided his or her unique CIDOR. ID that becomes the universal identifier for the user and is technology and device agnostic. The CIDOR ID is provided (FIG. 2) to the user when they sign in/register with the task management system using an input device and is linked with the user's to-do list task items contained within User Calendar Database. If the user provides third party providers with the CIDOR ID, then the receiving third party provider can create within the User Calendar Database to-do list task items which are linkable to third party provider solicitation for offers contained with the Offer Database (see generally, FIG. 16). The CIDOR ID further serves as a universal switch that can automatically route information and content as determined by User Profile setting (see generally, FIG. 2). Third party providers may deliver content directly to users by sending information or content to the task management system using a user's CIDOR ID. The task management system also provides a method for third party providers to communicate with other third party providers using the CIDOR ID.

By way of example and not as a limitation, businesses miss out on revenue when a customer misses the appointment, sale, promotion or another event such as a doctor's office that misses on revenue when a patient misses the appointment/to-do list task item or fails to inform of change in plans. Businesses or institutions or providers want to be able to therefore contact their customers or members in the way preferred by the latter to communicate (both ways) with them about relevant information such as new product arrivals, promotions, sales, desired product arrival, appointment addition or modification, service reminders, event reminders, other reminders etc. This is difficult at times because the customer/member may either not be willing to provide contact information such as their email address, address, phone number, etc. or their contact information has changed or the business or institution or provider doesn't know the customer's or member's preferred communication method. By way of example, and not as a limitation, a customer walks into the retail store and is really interested in buying an item when it a) becomes available or b) is on sale. The task management system allows for the customer to ask the retailer to send a reminder, advertisement, offer, solicitation, information and/or content, to the user's CIDOR ID when such events occur. The retailer utilizes the task management system to automatically generate such reminders, advertisements, offers, solicitations, information and/or content to the customer/user based on preferences specified in the latter's User Profile when the retailer indicates that the to-do list task item criteria has been met. The reminder may include important information that can help the user customer take action as well. The reminder may include information about the nearest store that has the item or include means to take other actions (e.g. purchase, hold etc.). In certain instances, the third party providers will also have their own User Calendar Databases that can be populated with to-do list task items initiated by other task management system user, and thereafter, the third party providers' systems can interface with the User Calendar Database containing such third party provider to-do list task items and, after comparison of events within the third party provider's system, trigger a notification response to the user based on relevant events effecting such to-do list task item, such third party provider's system inserting a relevant solicitation for offer and related offer criteria in the Offer Database, causing the task management system to insert a new to-do list task item within the User Calendar Database with a linkable object between this new to-do list task item and the new solicitation for offer contained within the Offer Database. By way of example, and not as a limitation, where the user has requested for a reminder from a retailer when a certain item becomes available or is on sale. The retailer stores this request which links with their inventory system triggering a reminder/to-do list task item to the user when the product becomes available (see generally, FIG. 16). In addition, the task management system also has the ability to insert solicitation for offers as linkable objects for association with to-do list task items within a User Calendar Database.

The task management system allows for third party providers and other users of the task management system to provide rewards criteria in association with the linkable solicitation for offers contained with the Offer Database. Rewards criteria may consist of rewards points, coupons, incentives, awards and other means of recognition and reward.

An embodiment of this invention is the capability of users and or third party providers to create “group task” items by creating common to-do list task items across multiple users (FIG. 15). By way of an example, but not a limitation, users who belong to a charitable group (e.g. March of Dimes) may establish a group, create a group to-do list task item (e.g. participate in the 10 K run on Jun. 10, 2011) and propagate the group to-do list task item to other members of the group that are users of the task management system. In the above example, without limitation, this could be accomplished by a single group user, a group administrator user, or the charitable group user of the task management system.

The task management system provides capabilities and the abilities for the user to pick from a central “Content Database” pictures, images, icons, sketches, recorded voices, videos, animations, sensory alerts, favorite statements/spoken words, voices/images/videos of celebrities/personalities/relatives/friends etc. (see generally, FIG. 2, FIG. 3, FIG. 4 and FIG. 5). Users and/or third party providers will be able to associate such content with individual user to-do list task items within the User Calendar Database and or solicitation for offers within the Offer Database. The present invention vastly expands on such features available in the market today. Current features available are limited to select/constrained set of sound alerts only, and do not differentiate based on to-do list task item category, context, or related to the third party provider or provider category, etc. The Content Database will contain a multitude of content choices for the user to pick from, including user uploaded, system licensed and/or impersonated, favorite spoken words of famous personalities, voices identifying a cause, animal sounds, bug sounds, character sounds/voices, etc. third party providers, that may include businesses, institutions, etc., can also publish sensory alerts, graphics, icons, pictures, voice, brand voice, video, animation etc. in the Content Database for them to be able to associate these Content Database items with the reminders related to the user's to-do list task items and solicitation for offers. These will also be accessible for the users to choose and utilize for their personal, non-business related reminders. The system may also use licensed samples of content e.g. photo, voice etc. from people to add to its database for users to connect and use for their to-do lists. By Way of example and not as a limitation, content may consist of any electronic media, such as formats consisting of JPEGS, BMPS, GIFS, TIFS, AVIS, MPEGS, MOVS, WAV, and MP3 or such other after developed formats.

Users and/or third party providers can also provide a plurality of content in various formats e.g. recorded voice(s)—voices can be any language, users', someone else's (e.g., child, new born baby) etc.—photos, images, icons, pictures, sketches, animation, photo of a celebrity/personality/relative/friend etc. to the Content Database through a plurality of means, including but not limited to, uploading; calling in directly to the system, integration with the system, interfaces, APIs, physical delivery, etc. The system may also provide a capability for the users to define, upload or create sensory alerts as well. The system will provide a filter to limit selection of content to be uploaded into the Content Database based on various pre-defined factors including but not limited to duration, size, format, profanity etc. These factors may be system defined and/or defined by the user community. Note that the content need not be customized to be uploaded. Users can also upload content for sale to other users or third party providers for a fee with the system charging a fee to the content creator.

The Content Databases can be created/populated/managed by either the system, third party providers or users or any combination therefore. The system and/or third party providers can provide access to such databases and/or differentiate access to items in such databases, to the user for free, for a fee, as an option to, purchase using reward points (from the system or external reward points) and /or on achieving certain targets.

The task management system also makes it fun and rewarding for the users to act on their to-do list task items by providing the capability to add personas to identify other users or third party providers who are adding tasks to their to-do list task items, in the User Profile by pointers/links to the Content Database (see generally FIG. 4, FIG. 5, and FIG. 6). These personas include but are not limited to photos of the other user, images, pictures, voices of the other user, icons, sketches, photos of a celebrity/personality picked by the other user, voice of the celebrity/personality picked by the other user, etc, all stored in the Content Database as either a public or private (i.e. accessible to other users, or only to the user uploading such data).

Even the user can represent his profile through their own photo, image, picture, video, animation, voice, sketch and/or similar content formats (e.g. photo, image, video, voice etc.) of a celebrity/personality, favorite song/TV serial, any other unique content that represents a unique identification etc.

Users will have an option to directly choose the alerts for their to-do list task items and/or allow the system or third party providers to determine the alerts. The alerts could be customized at multiple levels including but not limited to, a single alert for all to-do items for a user, specific to a category (to-do list task items, third party providers etc.), specific to a user, specific to the context of the task or specific to the user level and various other levels (see generally, FIG. 4). In another embodiment, the system can offer various sounds as alerts for the items on the user's to-do list task items. The user can select sounds, with duration of sound defined by the system, to be played when the to-do action item is within a certain threshold of task completion due date. In case of other users these can be their own voice, other voices uploaded by them and in case of other third party providers these can be brand tone (voice/sound that identifies the company), campaign tone (marketing campaign, election campaign, charity campaign, etc.), TV episode tone, movie tone, music/song tone etc. Upon the triggering of an alert associated with a to-do list task item or items, the content associated with such to-do list task item(s) will execute such that the designated user or third party providers shall receive said content. Alert sounds can be selected based on various parameters, e.g., by language/dialect, by tone, nature of the to-do list task item, mood, event, festival, accent, urgency, humor, etc. Alerts need not be only audible; alerts can consist of all forms of digital media referenced throughout this application or otherwise generally available.

The user can also receive alerts that uniquely represent and/or identify a third party provider (e.g., business, institution) when the proximity to that third party provider is detected in relation to the to-do list task item based on the User. Profile. An alert may include video, vibration, icons and other forms of cues that may be available to the system at given point in time and uniquely identify/represent the third party provider as indicated in the task management system. The user can receive such alerts through a plurality of means on various devices, including but not limited to a widget application on their desktop/laptop/mobile phones, emails to said system account, a touch tone phone, mobile phone, mobile terminal, SMS, voice, voice mail, electronic mail, instant messaging, kiosks, software application, automated voice announcement software etc. The user may or may not be mobile to receive such alerts.

The alerts could be for a given category of service that is determined to be contextually relevant to the to-do list task item. For e.g. a plumbing sound may be played for plumbing service providers while a milk bottle icon may be displayed and/or a milk related tune played when the user is near a business that sells milk and the related to-do list task item is about buying milk. In another embodiment, the alerts could be similar only for a given provider e.g. the advertisement sound for a particular telecommunications services provider. In yet another embodiment, the alerts may be different by area/location/region/country etc. for several , providers within the same umbrella/brand/company of a given service e.g. different franchises may have different sound/visual cues.

The task management system can also provide capabilities to convert to-do list task items from text to speech in the content options selected by the user and delivered to the user through plurality of means. E.g., if the user selected a celebrity voice as the content option, the system can provide the to-do list task items in the celebrity voice.

The task management system will also provide similar and more capabilities in a unique electronic mail service offered for the users i.e. the system will offer various audio or visual cues as alerts to inform them of the context of a new electronic message. The context includes but is not limited to message content, sender (type, characteristic), conversation thread, time of day and other plurality of factors that may be available to the system. The system may utilize such information to generate custom audio and/or visual cues to inform the user of the plurality of email context so the user may take appropriate action. An example, of which there are many, includes a scenario wherein the user may be informed that the new email is regarding information related to an action item. The task management system may present an animated icon or picture next to or in the subject line that is determined to be contextually relevant to the email message.

The task management system architecture is implemented on a server containing a central processing unit which is connected to a network, and having access to a data storage device wherein the central processing unit on the server is capable of maintaining, storing and retrieving data from database records of server hosted databases such as a User Account Database, a User Calendar Database, Content Database, Reward Database and, optionally, an Offer Database. A program will be executed on the server for facilitating the creation, calendaring and maintenance of individual and group to-do list task items by users within a hosted task management system, such task management system accessible by a plethora of users and/or third party providers via a client browser and permitting said users and/or third party providers, if said users and/or third party providers are authorized, to modify through an input means individual and group to-do list task items within said task management system or, alternatively, associate linkable objects from an Offer Database to individual and group to-do list task items within said task management system, such individual and group to-do list task items stored in a User Calendar Database. The program is further capable of aggregating a plethora of user to-do list task items into an aggregated to-do-list item for solicitation of offers from third party providers. The program will contain an automatic and/or user (or third party provider) accessible querying capability which will allow for the processing of to-do list task items and/or Offer Database contents based on categories and, if automatic, based on user preference, group preference, and offer preferences contained in the User Profile and/or Offer Database. The task management system is implemented on an interne or an intranet capable network. A client browser includes a network enabled personal computer, terminal, PDA, mobile phone, mobile terminal (FIG. 1A), Kiosks or Point of Sale System (POS), and any other similar devices referenced through this specification. The task management system may be accessible through such client browsers via an Application Programming Interface (API), such API capable of interfacing with the task management system for performing the system features as more fully set forth elsewhere in the specification. The task management system program is capable of associating digital media from the Content Database, either directly by download and storage to the User Calendar Database or User Profile or through linkable references thereto, with individual and group to-do list task items as virtual personal personas, virtual group personas, or to-do list task item alerts, as applicable.

If the hosting server running the task management system program does not contain an Offer Database or a remote Offer Database must be accessed, the task management system program will access, store and retrieve data from one or more additional servers containing a data storage device hosting one or more Offer Databases, such additional servers either remote or local and residing in a network with the hosting server running the task management system program. Such Offer Databases could reside on additional servers of third party providers which are capable of interfacing with the task management system through a network, intranet or interne. The task management system program is further capable of receiving and processing periodic data feeds from third party provider Offer Databases.

While the invention has been described with respect to particular illustrated embodiment, those skilled in the art and technology to which the invention pertains will have no difficulty devising variations which in no way depart from the invention. Accordingly, the present invention is not limited to the specific embodiments described above, but rather as defined by the scope of the appended claims and their equivalents.

### BRIEF DESCRIPTION OF THE DRAWINGS

For a more complete understanding, attached are drawings which show the system and method in various configurations.

FIG. 1 Task Management System and the various databases—internal or external (claim 1).

FIG. 2 Creation of the unique user identifier and user acronym (claims 2 and 4)

FIG. 3 Content Database (claim 5)

FIG. 4 Hierarchy of user selected virtual personas (claim 6)

FIG. 5 User Selection of virtual personas (claim 6)

FIG. 6 To-do list task creation and persona selection (claim 6)

FIG. 7 Matching offers to to-do task list items (claims 7-9)

FIG. 8 User selecting offers linked to task items (claim 10)

FIG. 9 Matching offers to to-do task list items (claim 13-14)

FIG. 10 Aggregation of to-do list task items (claims 17-19)

FIG. 11 Matching solicitations for offers to aggregated to-do list task items (claims 20-21)

FIG. 12 User accepting aggregated offer criteria to consummate transaction (claims 20-21)

FIG. 13 User accepting a solicitation for offer and system creating a to-do task list item (claims 23-25)

FIG. 14 User selecting linkable object offer (claims 26-27)

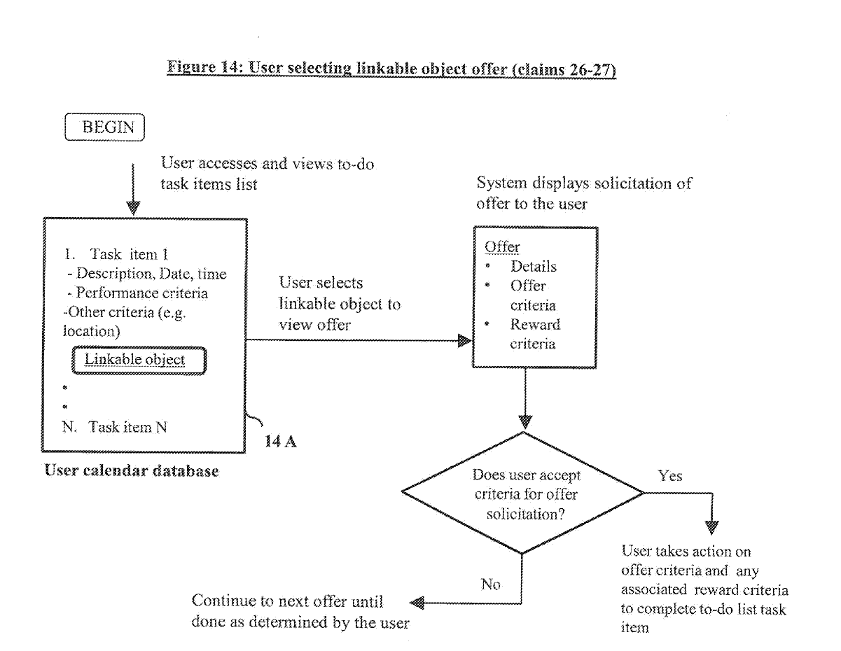

FIG. 15 Creation and insertion of group to-do list task items (claim 30)

FIG. 16. User acronym and 3^{rd} party solicitation for offer (claim 31-32)

### DETAILED DESCRIPTION OF THE PREFERRED EMBODIMENTS

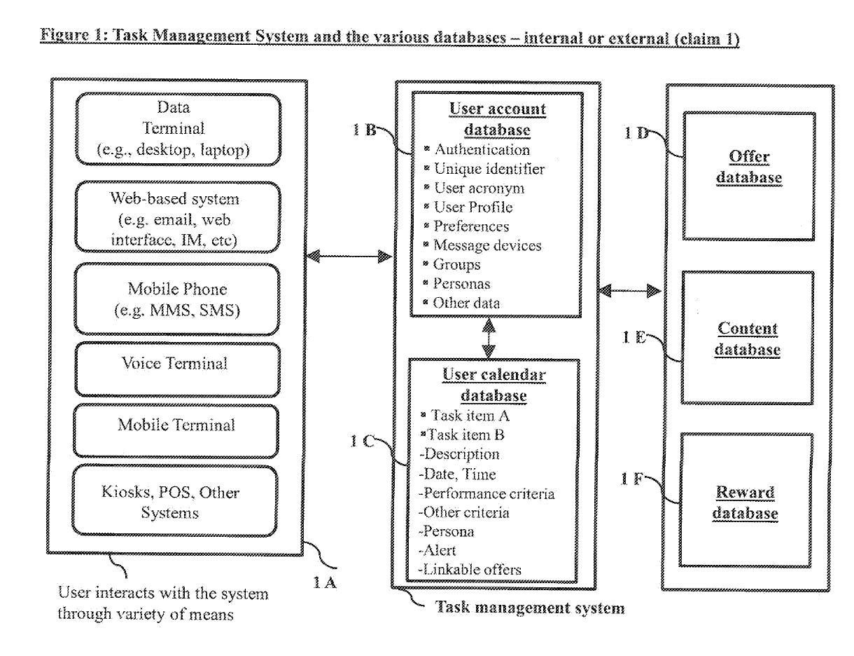

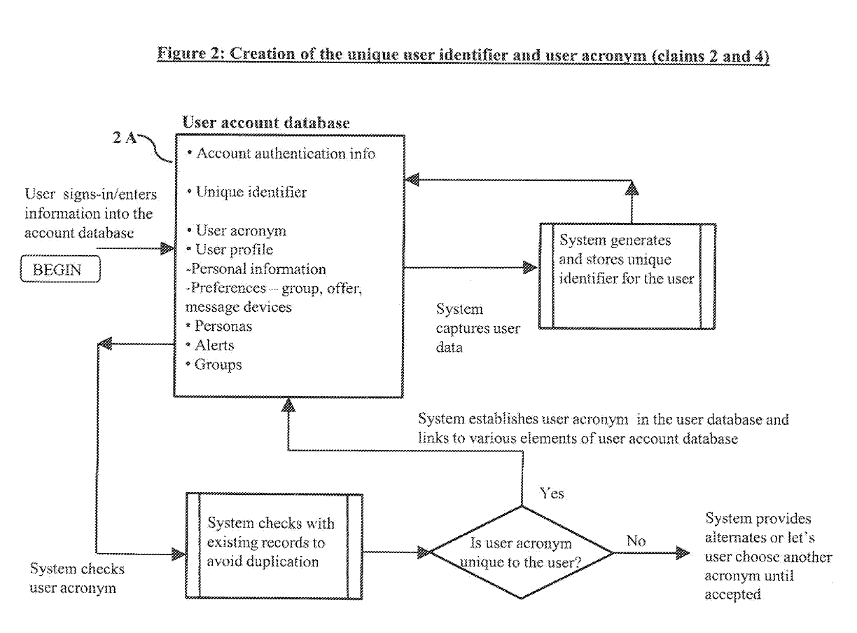

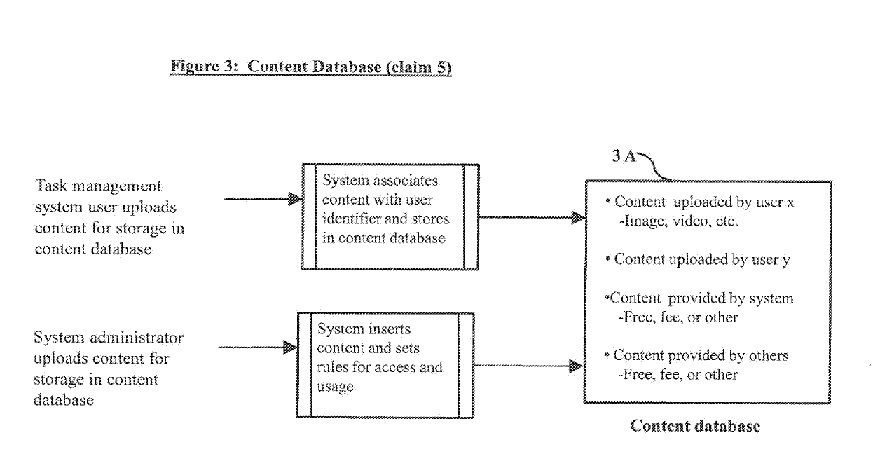

Generally, the present invention provides for a system and method for managing to-do list tasks items that utilizes a User Calendar Database, User Account Database, an Offer Database, Content Database, and a Reward Database. FIG. 1 shows that the User Account Database stores various user provided information, and the User Calendar Database stores the specific information and any associated criteria relating to a to-do list task item. A user, or third party provider, creates a to-do list task item within the User Calendar Database. A third party provider is only allowed to add, review and/or modify a to-do list task item of a user in accordance with such user authorization in the User Account Database, such third party provider then capable of allocating rewards from a reward database to user for completing such to-do list task item. FIG. 1 further shows a means of inputting data (FIG. 1A) into the User Account Database and User Calendar Database for creation of User Profiles and to-do list task items, respectively. The task management system creates a unique identifier within the User Account Database (FIG. 2A) which can be used to track and maintain to-do list task items and any third party solicitation for offers. The Content Database (FIG. 3) operates as a repository of digital media uploaded and stored either by the user, a third party provider, or the task management system administrator, as more fully described in the specification. The task management system requires a user computing device (terminal) capable of accessing a network connected to a server running the task management system, such task management system hosting and processing through a processing device the User Account Database, User Calendar Database, Offer Database, Content Database, and Reward Database, such database stored on a computer storage device and such task management system operated by a central processing unit.

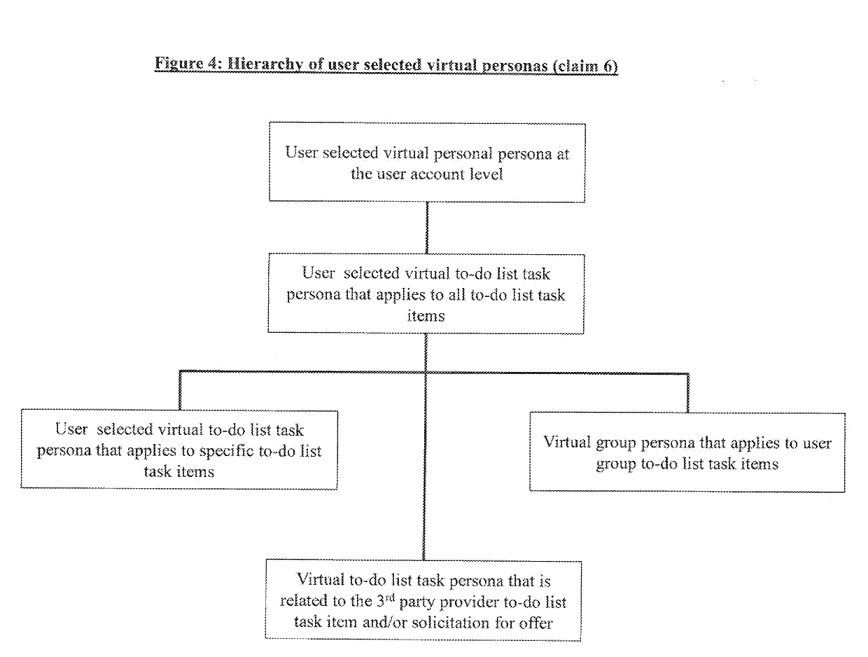

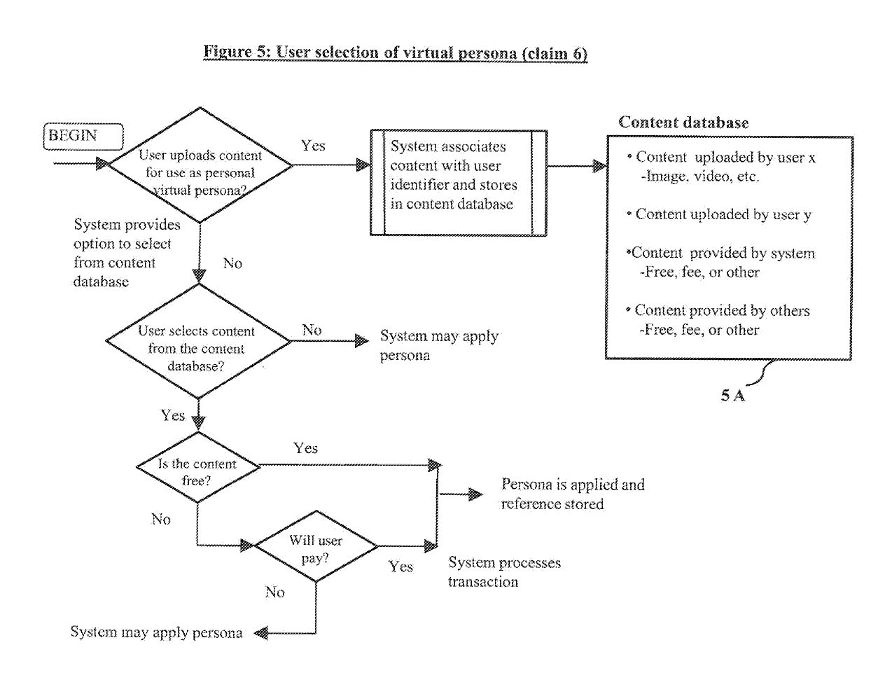

The task management system, allows the user to select virtual personas from the Content Database both for use with user to-do list task items in the Calendar Database and the User Profile for identifying a user within the task management system (FIG. 4 and FIG. 5.) Specifically, a user can upload digital media for storage in the Content Database for use as said user's persona (both at the task item level and user account/profile level), or the user can purchase or acquire free or for a fee or through reward criteria, digital media from the Content Database.

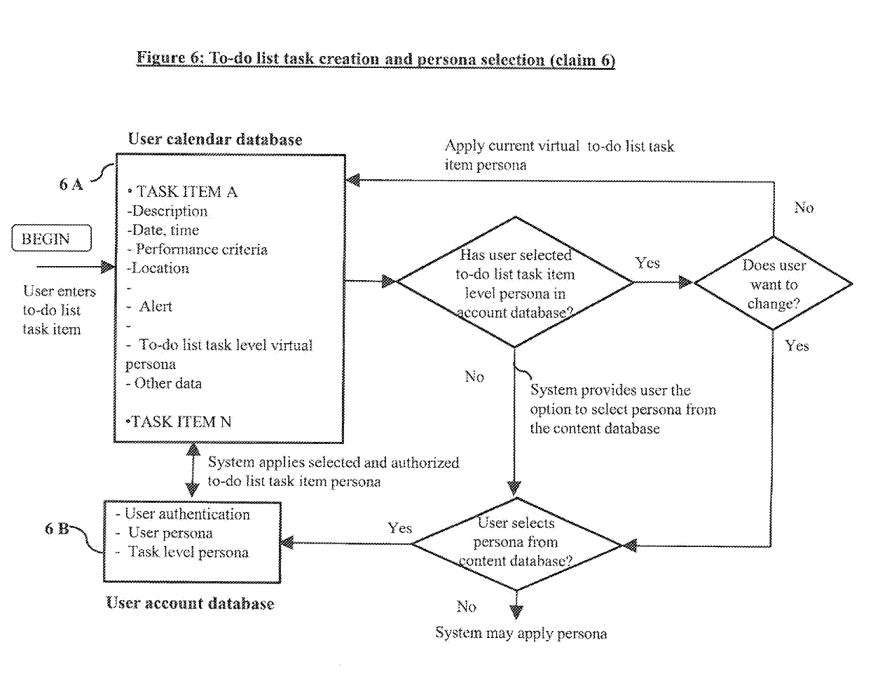

After the user has created a user account, defined user preferences within the User Account Database, and has been assigned a unique identifier (CIDOR), the user can then create a to-do list task item. This to-do list task item can adopt the account level virtual persona, or adopt a to do-list task item personal, as determined by the user (FIG. 6). As shown by FIG. 6A, the to-do list task item contains a description, date and time, performance location, performance criteria, virtual to-do list task item task persona, group preferences, permissions, an alert, and other data associated with the creation and identification of the task. The resulting to-do list task item is stored within the User Calendar Database, and made accessible to third party providers as determined by user. An alert can consist of an audible alert, vibration, or any digital media contained within the Content Database.

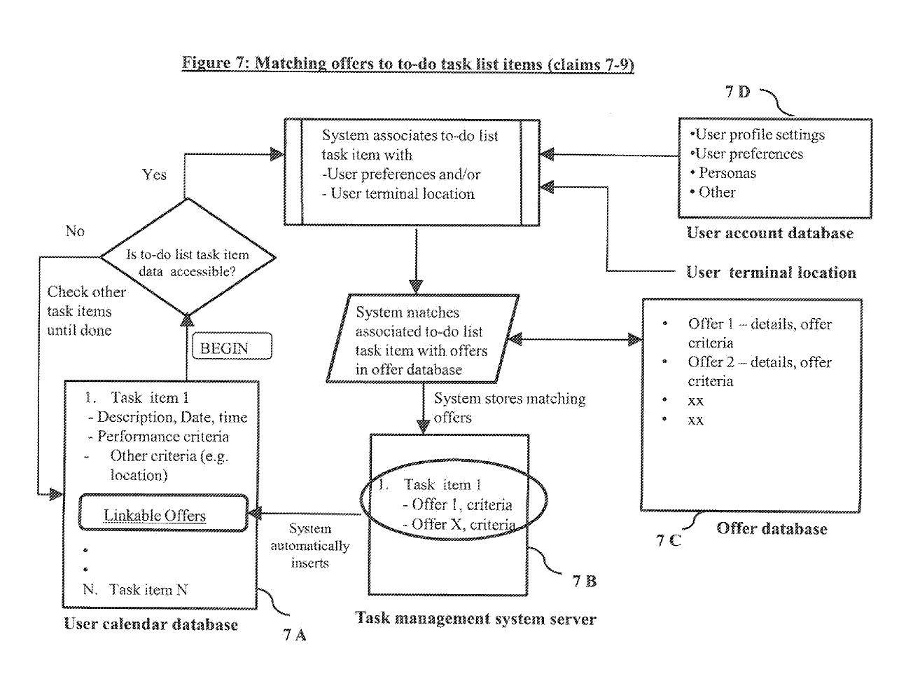

In an embodiment of the present invention, FIG. 7, shows where accessible to-do list task items are accessed automatically by the task management system and periodically compared against the Offer Database, such comparisons occurring in accordance with pre-defined filters and preferences established by the user (FIG. 7D) and the task management system. Upon comparison with the Offer Database (FIG. 7C and FIG. 7B), the system generates a storable subset of potential solicitation for offers meeting the requirements of user's to-do list task item and inserts a linkable object for association to such to-do list task item within the User Calendar Database. Optionally, and in addition to the user settings shown in FIG. 7D, the task management system may access and use the terminal location of the user for purposes of generating and storing linkable objects and or sending related notifications to user in accordance with preferences in the User Profile

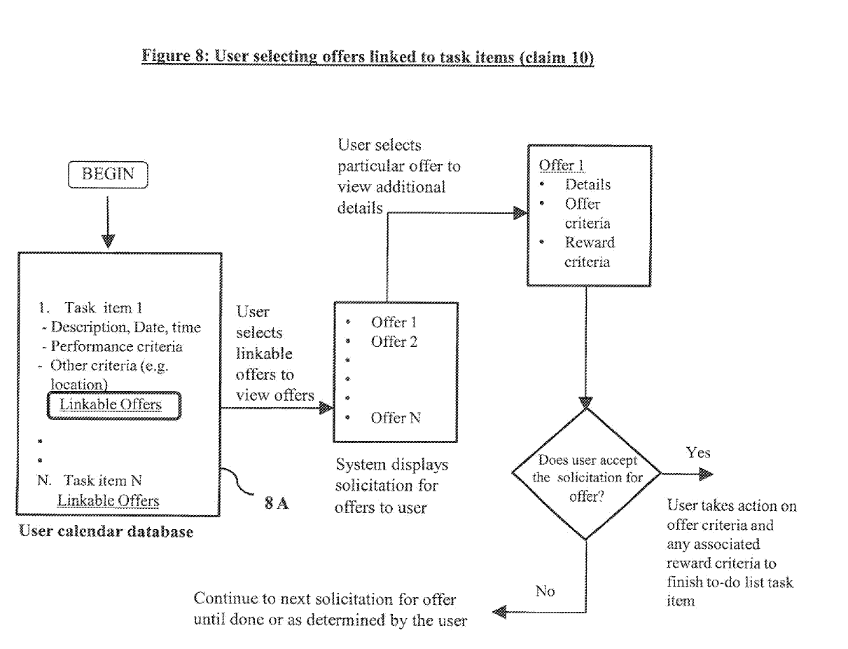

In another embodiment, a user can access linkable solicitation for offers stored within the Offer Database of the task management systems by third party providers or other users (FIG. 8.). The offers are displayed to user via a user display device such as a display screen. The user may select the linkable offer by way of a phone, keyboard, mouse, display screen, or a touch device. Upon selection, the user may either accept the solicitation for offer or decline the solicitation for offer upon reviewing the solicitation for offer criteria and related reward criteria. If the solicitation for offer is accepted, then the user can consummate the transaction associated with such offer; otherwise, the user can ignore the offer and choose not to interact with the offer at that time. Upon notification that a user has consummated the transaction associated with such offer, the reward criteria is transferred within the Reward Database to the User Account Database for use by user at a later time or, alternatively, the reward criteria is redeemed at the time of the consummated transaction.

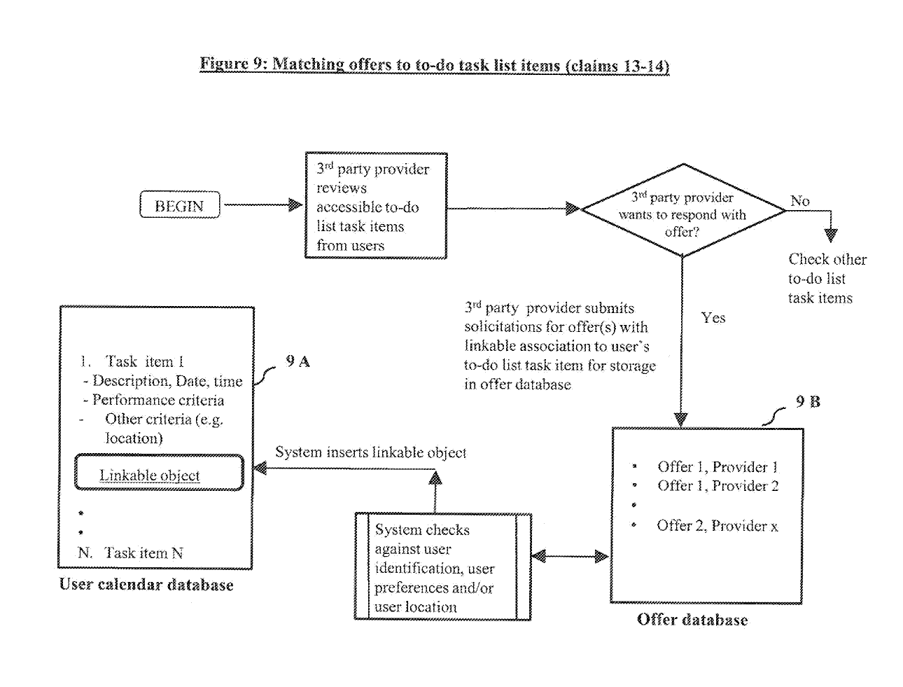

In another embodiment, third party providers can access to-do list task items of task management system users provided such users have authorized such access in the User Account Database (FIG. 9). Upon access, those to-do list task items are displayed to such third party providers. If such third party providers, after review of a users to-do list task items, desire to submit a solicitation for offer (FIG. 9B), then such third party provider populates the Offer Database with a solicitation for offer directed to said users to-do list task items, and the task management system inserts and stores a linkable object for association to such to-do list task item within the User Calendar Database. Similar to FIG. 8, the user may then select the linkable offer by way of a phone, keyboard, mouse, display screen, or a touch device. Upon selection, the user may either accept the solicitation for offer, or decline the solicitation for offer upon viewing the offer criteria and related reward criteria. If the offer is accepted, then the user can consummate the transaction associated with such offer; otherwise, the user can ignore the offer and choose not to interact with the offer at that time. Upon notification that a user has consummated the transaction associated with such offer, the reward criteria is transferred within the Reward Database to user.

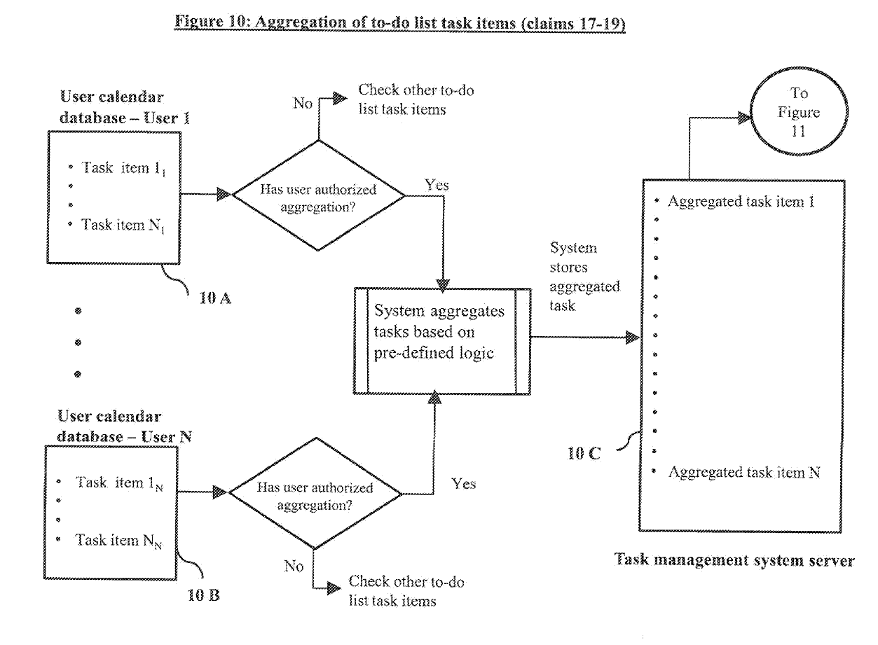

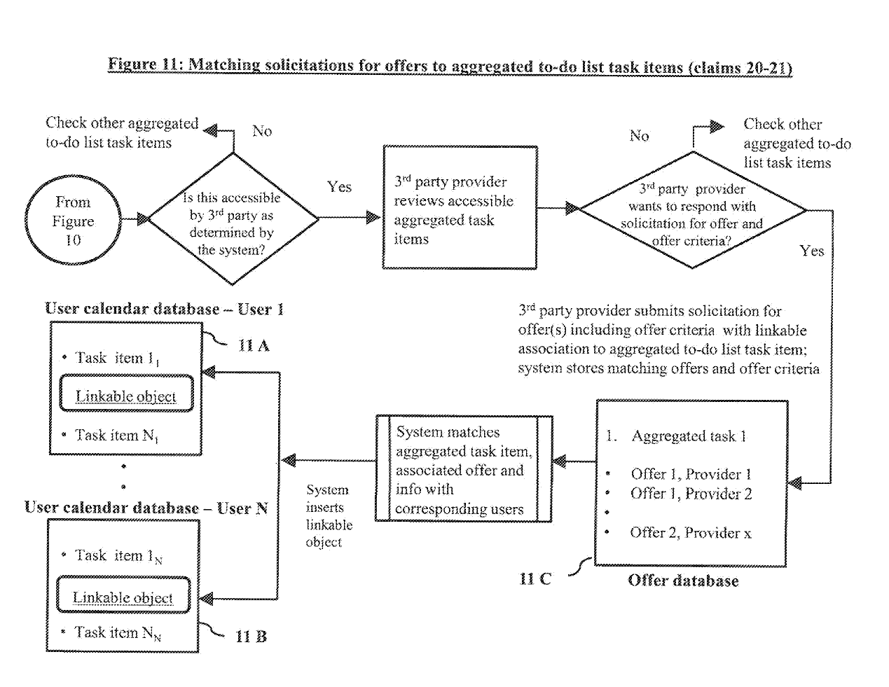

Another embodiment of the present invention is shown in FIG. 10 wherein third party accessible to-do list task items are accessed automatically by task management system and, if authorized by the user, aggregated against other task management system users to-do list task items for comparison against the Offer Database, such comparison occurring in accordance with pre-defined filters/categories and preferences established by each aggregated user (FIG. 10 and FIG. 11). Third party providers then access aggregated to-do list task items as a single aggregated to-do list task offer (FIG. 11). Upon access, the aggregated to-do list task item is delivered to such third party providers. The third party provider may select the aggregated to-do list item task for review by way of a phone, keyboard, mouse, display screen, a touch device, or third party provider automated systems processing such linkable offers. If such third party providers, after review or processing of the aggregated to-do list task item, desire to submit a solicitation for offer (FIG. 11), then such third party provider populates the offer database with a solicitation for offer directed to said aggregated to-do list task item, and thereafter the task management system inserts and stores a linkable object for association to such to-do list task item within the User Calendar Database of each aggregated user. If the solicitation for offer is accepted by all or some of the aggregated users, then those accepting aggregated users must consummate the transaction associated with such solicitation for offer. Upon notification that the accepting aggregated users have each consummated the transaction associated with such aggregated solicitation for offer, the reward criteria is transferred within the Reward Database to the accepting aggregated users in an allocation determined by the task management system, such as a pro rata allocation or other percentage based allocation.

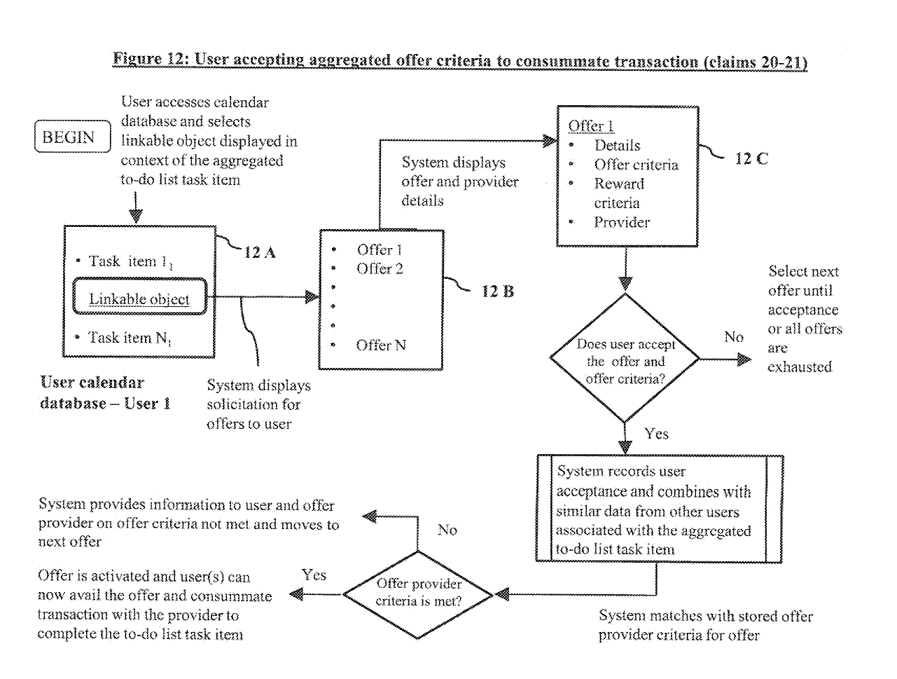

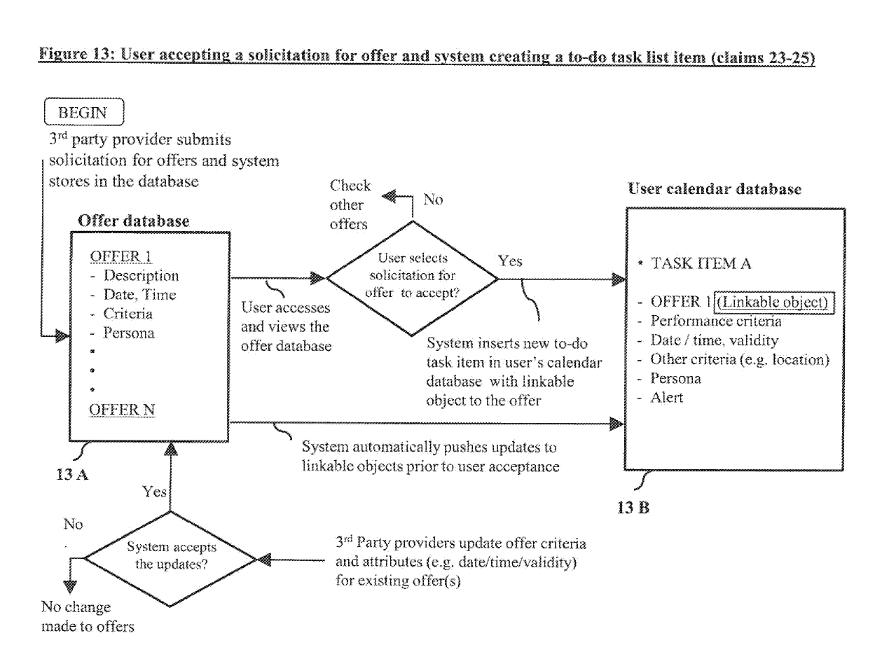

In another embodiment, a user may periodically review third party provider solicitations for offer contained within the Offer Database (FIG. 13A), and upon selection, the system will display such third party solicitations for offer to the user for acceptance. If the user accepts the solicitations for offer, then the task management system inserts and stores a new to-do list task item within the User Calendar Database and associates a linkable object to the accepted solicitations for offer within the Offer Database to such new to-do list task item. (FIG. 12B). Importantly, third party providers may periodically update the linkable object now associated with such to-do list task item and, upon acceptance by the task management system of such an update, the task management system updates the linkable object for associated with such to-do list task item within the User Calendar Database. Thereafter, and upon selection as shown in FIG. 13, the user may either accept the solicitation for offer, or decline the solicitation for offer upon viewing the offer criteria and related reward criteria. If the offer is accepted, then the user can consummate the transaction associated with such offer; otherwise, the user can ignore the offer and choose not to interact with the offer at that time. Upon notification that a user has consummated the transaction associated with such offer, the reward criteria is transferred within the Reward Database to user.

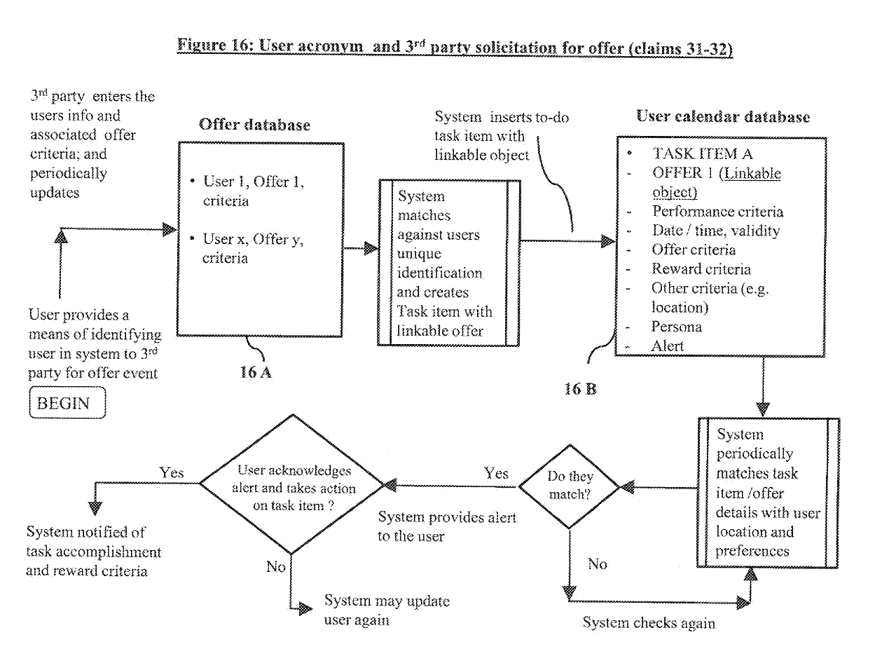

In another embodiment, a user may provide his unique identifier (CIDOR) to third party providers for future submissions of solicitations for offers to the user, as determined by such third party providers. If such third party providers desire to submit a solicitation for offer (FIG. 16), then such third party provider electronically sends a solicitation for offer to the task management system with reference to the user's unique identifier (CIDOR), the task management system automatically populates the Offer Database with a solicitation for offer directed to said user's unique identifier (CIDOR) (FIG. 16A), and the task management system inserts a linkable object for association to such user's to-do list task item within the User Calendar Database (FIG. 16B). Similar to FIG. 8, the user may then select the linkable offer by way of a phone, keyboard, mouse, display screen, or a touch device. Third party providers may periodically update the linkable object now associated with such to-do list task item and, upon acceptance by the task management system of such an update, the task management system updates the linkable object for associated with such to-do list task item within the User Calendar Database. Upon selection, the user may either accept the solicitation for offer, or decline the solicitation for offer upon viewing the offer criteria and related reward criteria. If the offer is accepted, then the user can consummate the transaction associated with such offer; otherwise, the user can ignore the offer and choose not to interact with the offer at that time. Upon notification that a user has consummated the transaction associated with such offer, the reward criteria is transferred within the Reward Database to user.

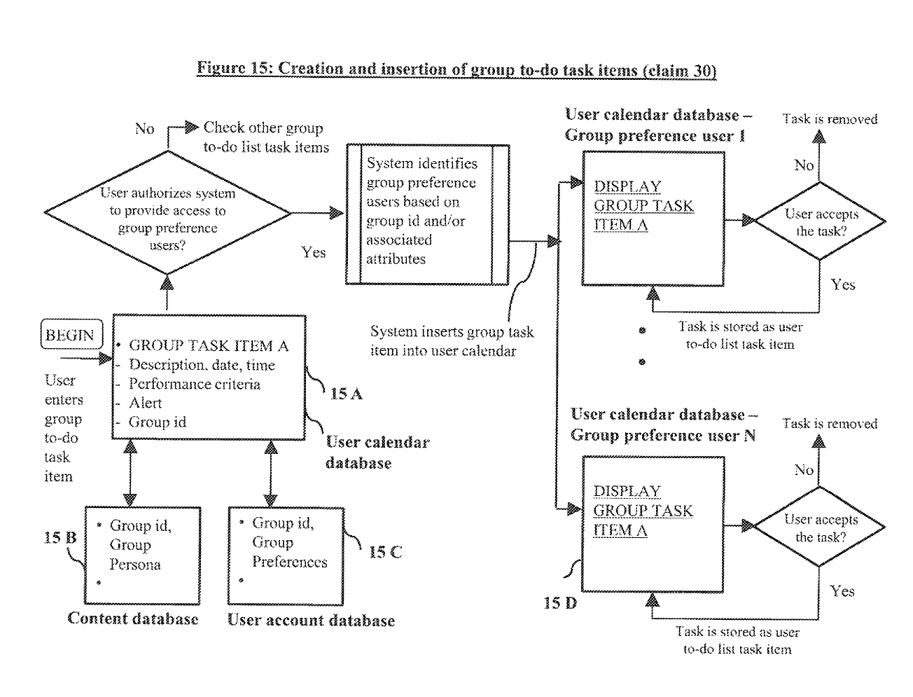

In another embodiment, user of the task management system can create a group to-do list task item (FIG. 15). Group task users must have identified themselves in the User Account Database as group task users (FIG. 15C) and may have common virtual group persona selected from the Content Database (FIG. 15D). If a group task user has authorized the task management system to provide group access to calendaring and to-do list task item management, then the task management system will display (FIG. 15D) the created group to-do list task item to relevant group users and, if acceptable by such relevant group users, the task management system inserts and stores a new to-do list task item in each relevant group users to-do list task item Calendar Database.

While the above description is of the preferred embodiment of the present invention, it should be appreciated that the invention may be modified, altered, or varied without deviating from the scope and fair meaning of the following claims.

What is claimed:

1. A method implemented on a server for managing individual and group to-do list task items in a task management system, comprising: said server connected to the Internet, said server maintaining a user account database for users of the task management system; said server maintaining a user calendar database for users of the task management system; said server communicating with an offer database for users of the task management system; said server communicating with a content database for users of the task management system; and said server communicating with a reward database for users of the task management system, said server connected to a network and facilitating the creation, calendaring and maintenance of individual and group to-do list task items by users within a web hosted task management system, such task management system accessible by a plethora of users via a client browser and permitting said users, if said users are authorized, to modify at least one of said individual and group to-do list task items within said task management system.

2. The method of claim 1, wherein the user account database includes account authentication information, a user unique identifier; a user acronym selected from a group consisting of a user provided identification, a user e-mail address, and a user phone number, such user acronym associated with said unique identifier; a user selected virtual personal persona; a user selected virtual group persona; a user selected virtual to-do list task item task persona, a user selected hierarchy of group preferences, a user selected hierarchy of offer preferences, a user selected hierarchy of message devices, and a user defined alert for to-do list task item task message reminders, and user personal profile information within said to-do list task item task management system.

3. The method of claim 1, wherein the offer database includes at least one solicitation for an offer from: third party providers of services, third party providers of products, and other users of said task management system, each solicitation for an offer containing a reward criteria of at least one of the following: digital media, points, coupons, and message information such reward criteria stored within said offer database.

4. The method of claim 3, wherein said account authentication information includes a user id and a password; said unique identifier is randomly generated by said to-do list task item task management system; said message devices includes at least one physical mailing information, telephone information, instant messaging information, e-mail information, pager information, terminal information, and mobile terminal information; said personal profile information includes said user's name and e-mail address; said group preferences includes at least one list of task management system users who are familial to said user, list of task management system users who are within said user's social network, list of task management system users who are non-profit business entities, list of task management system users who are service providers, and list of task management system users who are customers of said user; said offer preferences consist of at least one of the following an offer location preference, brand name preference, purchase price preference, rebate preference, volume discount preference, environmentally green product preference, delivery preference, and consent to aggregation of said user's offer preferences data with other users of said task management system.

5. The method of claim 4, wherein said content database includes at least one of the following: said user's uploaded digital media; free user preloaded digital media uploaded by other task management system users, fee-base licensable preloaded digital media uploaded by task management system users, free preloaded digital media by the task management system administrator, or fee-base licensable preloaded digital media by the task management system administrator.

6. The method of claim 6, further comprising steps wherein said users select virtual personal persona from said content database for storage in said user account database, said users select said virtual group persona from said content database for storage in said user account database, said users select said virtual to-do list task item task persona from said content database for storage in said user account database.

7. The method of claim 6, further comprising steps wherein said user creates a to-do list task item which includes at least one description, date, time, performance location, virtual to-do list task item task persona, a to-do list task item alert, and said to-do list task items are stored in the user calendar database, and accessible by at least one of the following: other task management systems users, and said task management system administrator.

8. The method of claim 7 further comprising steps wherein said task management system administrator compares accessible user to-do list task items with at least one of the following:
said user's offer preferences, said user's terminal location, and said task management system offer database; and said task management system generates and stores in said server memory a subset of relevant solicitation for offers matching the comparison criteria.

9. The method of claim 8 further comprising steps wherein said task management system inserts linkable object into said user's to-do list task item of said user's calendar database, such linkable object including a link to at least one relevant solicitation for offer in the offer database.

10. The method of claim 9 further comprising steps wherein said user selects said inserted linkable object for said solicitation for offer, said solicitation for offer is displayed to said user's client browser, said user electronically accepts said solicitation for offer, and said reward criteria for said accepted solicitation for offer is transferred from said offer database to said reward database and referentially associated with said user account database of said user.

11. The method of claim 6, further comprising steps wherein said user creates to-do list task items which includes at least one to-do list task item task offer preference, description, date, time, performance location, virtual to-do list task item task persona, a to-do list task item alert, and said to-do list task items are stored in the user calendar database, and said user has authorized said to-do list task items be accessible by said task management system administrator.

12. The method of claim 11 wherein said to-do list task offer preferences consist of at least one of the following an offer location preference, brand name preference, purchase price preference, rebate preference, volume discount preference, environmentally green product preference, delivery preference, and consent to aggregation of said user's offer preferences data with other users of said task management system.

13. The method of claim 12, further comprising steps wherein said task management systems makes accessible said user created to-do list task items to said third party providers.

14. The method of claim 13, further comprising steps wherein said third party providers reviews said user created to-do list task items and said third party providers electronically submit to said task management system for storage in said offer database at least one of the following: a solicitation for offer for linkable association with said user created to-do list task items, and a correspondence concerning said user created to-do list task items, and wherein said solicitation for offer and said correspondence is displayed to said user in accordance with said user's offer preferences and message device preferences.

15. The method of claim 14, further comprising steps wherein said user accepts said solicitation for offer, said third party provider and said user consummate a transaction relating to said solicitation for offer, said third party provider notifies said task management system that said transaction is complete, and said reward criteria for said accepted solicitation for offer associated with said transaction is transferred from said offer database to said reward database and referentially associated with said user account database of said user.

16. The method of claim 6, further comprising steps wherein said user creates to-do list task items which includes at least one to-do list task item task offer preference, description, date, time, performance location, virtual to-do list task item task persona, a to-do list task item alert, and said to-do list task items are stored in the user calendar database.

17. The method of claim 16, further comprising steps wherein said user has authorized said to-do list task items be accessible by said task management system administrator, and said user has requested said task management system administrator aggregate said to-do list task items with other to-do list task items of other users within said task management system who have likewise authorized aggregation.

18. The method of claim 17, further comprising steps wherein said task management system performs an aggregation of said to-do list task items with similar to-do list task items of other users who have authorized aggregation, and said task management system generates and stores in said server memory a subset of relevant aggregation offers.

19. The method of claim 18, further comprising steps wherein said task management system stores in said server a single aggregated to-do list task item, comprised of the results of said aggregation, within a task management system calendar which is accessible and displayed by the task management system to at least one of the following: third party providers, and other users of the task management system.

20. The method of claim 19, further comprising steps wherein said third party provider reviews said single aggregated to-do list task item, and said third party providers electronically submit to said task management system for storage in said offer database at least one of the following: a solicitation for offer for linkable association with said user created to-do list task items, and a correspondence concerning said user created to-do list task items; and said task management system inserts linkable objects into the to-do list task items of aggregated users calendar(s), such linkable object including at least one relevant offer contained within said solicitation for offer from the offer database and/or said correspondence.

21. The method of claim 20, further comprising steps wherein said user selects said inserted linkable object for said solicitation for offer, said solicitation for offer is displayed to said user's client browser, said user electronically accepts said solicitation for offer.

22. The method of claim 21, further comprising steps wherein at least two aggregated users have electronically accepted said solicitation for offer, said task management system notifies said third party provider that said aggregate users have electronically accepted said solicitation for offer, said third party provider and said aggregated users consummate a transaction relating to said solicitation for offer, said third party provider electronically notifies said task management system that said transaction is complete, and said reward criteria for said solicitation for offer associated with said transaction is transferred from said offer database to said reward database and referentially associated with said aggregated users user account database in a proportion determined by the task management system.

23. The method of claim 6 further comprising steps wherein said third party providers electronically submit to said task management system for storage in said offer database at least one of the following: a solicitation for offer from the offer database for linkable association with said user created to-do list task items, and a correspondence concerning said user created to-do list task items, and wherein said solicitation for offer and said correspondence is made accessible to said user in accordance with said user's message device preferences.

24. The method of claim 23, further comprising steps wherein said user has accessed said offer database, said solicitation for offer has been displayed to said user, said user has selected said solicitation for offer link, and, in response to said user's selection, said task management system inserts a new to-do list task item into said users calendar with a linkable object, such linkable object including a link to said solicitation for offer from the offer database.

25. The method of claim 24 wherein said new to-do list task item includes at least one description, date, time, performance location, virtual to-do list task item task persona, and a to-do list task item alert in accordance with said user preferences, said new to-do list task item modifiable by said task management system with said third party provider updates of said solicitation for offer.

26. The method of claim 25, further comprising said steps wherein said user selects said inserted linkable object for said solicitation for offer, said solicitation for offer is displayed to said user's device preferences, said user electronically accepts said solicitation for offer.

27. The method of claim 26, further comprising steps wherein said user accepts said solicitation for offer, said third party provider and said user consummate a transaction relating to said solicitation for offer, said third party provider notifies said task management system that said transaction is complete, and said reward criteria for said solicitation for offer associated with said transaction is transferred from said offer database to said reward database and referentially associated with said user account database of said user.

28. The method of claim 6, further comprising steps wherein said user creates to-do list task items which includes at least one to-do list task item task offer preference, description, date, time, performance location, virtual to-do list task item task persona, a to-do list task item alert, and said to-do list task items are stored in the user calendar database; wherein said user further associates said to-do list task items with said group preference and said virtual group persona.

29. The method of claim 28, further comprising steps wherein said user authorizes the task management system to make said to-do list task items available to those group preference users for inclusion on said group preference users calendars.

30. The method of claim 29, further comprising steps wherein said group preference users accept said to-do list task item, and said group preference users authorized said task management system to utilize said individual group preference users virtual personas, wherein the task management system modifies said virtual personas into a plethora of proposed virtual group personas, and allows said group preference users to select said proposed virtual group personas for inclusion as the designated virtual group personas for said group preference members who have accepted said to-do list task items.

31. The method of claim 6, further comprising steps wherein said user provides a third party provider said user's created acronym, wherein said third party provider periodically provides said task management system with offers electronically submitted to said task management system for storage in said offer database including at least one of the following: a solicitation for offer stored in said server memory, and a correspondence concerning said solicitation for offer.

32. The method of claim 31, further comprising steps where said task management systems compares said solicitation for offers against at least one of the following: user's created acronym, said user's offer preferences, and said user's terminal location; and task management generates and stores a subset of relevant solicitations for offers matching the comparison criteria; said task management system inserts linkable objects into said user's to-do list task item of said user calendar database, such linkable object including at least one relevant solicitations for offer from the offer database; and said solicitation for offers is made accessible to said user in accordance with said user's message device preferences and said user is alerted to the solicitations for offers through said user's to-do list task item alert.

33. The method of claim 32, further comprising steps wherein said user accepts said solicitation for offer, said third party provider and said user consummate a transaction relating to said solicitation for offer, said third party provider electronically notifies said task management system that said transaction is complete, and said reward criteria for said solicitation for offer associated with said purchase transferred from said offer database to said reward database and referentially associated with said user account database of said user.

34. A electronic to-do list task item task management system implemented on a server for managing individual and group to-do list task items in a task management system, comprising:
said server containing a central processing unit, connected to a network, a data storage device accessible by said server for storage and retrieval of database records, said server maintaining a user account database for users of the task management system; said server maintaining a user calendar database for users of the task management system; said server communicating with an offer database for users of the task management system; said server communicating with a content database for users of the task management system; and said server communicating with a reward database for users of the task management, said server connected to a network, a program executing on said server for facilitating the creation, calendaring and maintenance of individual and group to-do list task items by users within a hosted task management system, such task management system accessible by a plethora of users via a client browser and permitting said users, if said users are authorized, to modify through an input means at least one of said individual and group to-do list task items within said task management system, said program further capable of aggregating a plethora of user to-do list task items for solicitation of offers from third party providers.

35. The electronic to-do list task item task management system of claim 34, wherein the user account database includes account authentication information, a user unique identifier; a user acronym selected from a group consisting of a user provided identification, a user e-mail address, and a user phone number, such user acronym associated with said unique identifier; a user selected virtual personal persona; a user selected virtual group persona; a user selected virtual to-do list task item task persona, a user selected hierarchy of group preferences, a user selected hierarchy of offer preferences, a user selected hierarchy, of message devices, and a user defined alert for to-do list task item task message reminders selected by user from said content database, and user personal profile information within said to-do list task item task management system.

34. The electronic to-do list task item task management system of claim 35, wherein the offer database includes at least one solicitation for an offer from: third party providers of services, third party providers of products, and other users of said task management system, each solicitation for an offer containing a reward criteria of at least one of the following: digital media, points, coupons, and message information, such reward criteria stored within said offer database.

35. The electronic to-do list task item task management system of claim 34, wherein said account authentication information includes a user id and a password; said unique identifier is randomly generated by said to-do list task item task management system; said message devices includes at least one physical mailing information, telephone information, instant messaging information, e-mail information, pager information, terminal information, and mobile terminal information; said personal profile information includes said user's name and e-mail address;
said group preferences includes at least one list of task management system users who are familial to said user, list of task management system users who are within said user's social network, list of task management system users who are non-profit business entities, list of task management system users who are service providers, and list of task management system users who are customers of said user; said offer preferences consist of at least one of the following an offer location preference, brand name preference, purchase price preference, rebate preference, volume discount preference, environmentally green product preference, delivery preference, and consent to aggregation of said user's offer preferences data with other users of said task management system.

36. The electronic to-do list task item task management system of claim 35, wherein said content database includes at least one of the following: said user's uploaded digital media; free user preloaded digital media uploaded by other task management system users, fee-base licensable preloaded digital media uploaded by task management system users, free preloaded digital media by the task management system administrator, or fee-base licensable preloaded digital media by the task management system administrator.

37. The electronic to-do list task item task management system of claim 36, wherein said user has accessed said offer database, said solicitation for offer has been displayed to said user, said user has accepted said solicitation for offer link, and, in response to such acceptance, said task management system inserts a new to-do list task item into said users calendar with a linkable object contained within the offer database, such linkable object including at least one relevant solicitation for offer.

38. The electronic to-do list task item task management system of claim 37, wherein said task management system sends electronic reminders to said user's message device preferences and said user is alerted to the solicitations for offers through said user's to-do list task item alert.

39. The electronic to-do list task item task management system of claim 38, wherein said, said third party provider and said user consummate a transaction relating to said solicitation for offer associated with said new to-do list task item, said third party provider notifies said task management system that said transaction is complete, and said reward criteria for said solicitation for offer associated with said transaction is transferred from said offer database to said reward database and referentially associated with said user account database of said user.
